(19) United States
(12) Patent Application Publication
(10) Pub. No.: US 2014/0350788 A1
(43) Pub. Date: Nov. 27, 2014

(54) METHOD FOR CONTROLLING STOP MODES OF MOTER-DRIVEN POWER STEERING

(71) Applicant: MANDO CORPORATION, Pyeongtaek-si (KR)

(72) Inventor: Tae Wan Byun, Seongnam-si (KR)

(73) Assignee: MANDO CORPORATION, Pyeongtaek-si (KR)

(21) Appl. No.: 14/093,978

(22) Filed: Dec. 2, 2013

(30) Foreign Application Priority Data
Nov. 30, 2012 (KR) 10-2012-0138468

(51) Int. Cl. B62D 5/04

(52) U.S. Cl. CPC B62D 5/0484
USPC 701/41

(57) ABSTRACT

Exemplary embodiments of the present invention relate to a method for controlling stop modes of a motor-driven power steering capable of suppressing discharging of a battery While enhancing driver's convenience and safety by combining and determining various states of a vehicle. In accordance with an embodiment of the present invention, a method for controlling stop modes of a motor-driven power steering includes: a first step of confirming Whether a vehicle speed of a vehicle is present; a second step of confirming whether an engine of the vehicle is operated; a third step of confirming whether an alternator is driven or an ignition switch is turned on or off; and a fourth step of delaying the stop of the motor-driven power steering for a predetermined different time depending on a confirmation result in the first, second, and third steps.

### CROSS-REFERENCE(S) TO RELATED APPLICATIONS

This application claims priority to Korean Patent Application No. 10-2012-0138468, filed on Nov. 30, 2012, which is incorporated herein by reference in its entirety.

### BACKGROUND OF THE INVENTION

1. Field of the Invention

Exemplary embodiments of the present invention relate to a method for controlling stop modes of a motor-driven power steering, and more particularly, to a method for controlling stop modes of a motor-driven power steering capable of suppressing discharging of a battery while enhancing driver's convenience and safety by combining and determining various states of a vehicle.

2. Description of Related Art

A motor-driven power steering (MDPS) (or electrical power steering (EPS)) is a steering assistance apparatus which is mounted in a vehicle to enable a driver to easily control a steering wheel with a small force. When using the motor-driven power steering, a driver may drive a vehicle in a stable state by resolving a problem of reduced steering force of the steering wheel which occurs due to reduction in as grip force with a road surface even when he/she drives a vehicle on a sharp curve road at a high speed.

The MDPS is a module which consumes a large current and is operated when a battery is charged by an operation of a vehicle alternator. When the driver starts a vehicle to operate an engine, the MDPS starts to drive. When the MDPS is continuously operated even after starting of a vehicle stops, the battery may be discharged.

Meanwhile, when the MDPS stops during driving of a vehicle under the driver's unwanted situation, the driver is difficult to control a steering power, such that a risk of accident may increase. For example, when a user turns off the ignition of a vehicle on a sloping road by mistake, when the user turns off an ignition switch or an engine during the driving by mistake or at abnormality of a vehicle, when a first condition on a state of the ignition switch, and the like during the driving of the MDPS or a second condition on a vehicle speed, and the like is in a confirmation impossible state, that is, a state such as a disconnection or a short of a controller area network (CAN) line, message abnormality, and the like, if the MDPS stops suddenly, it is highly likely to cause an accident.

### RELATED ART DOCUMENT

### Patent Document

(Patent Document 1) Korean Patent Laid-Open Publication No. 104997-0040987 (Jul. 24, 1997)

### SUMMARY OF THE INVENTION

An embodiment of the present invention is directed to a method for controlling stop modes of a motor-driven power steering capable of suppressing discharging of a battery while enhancing driver's convenience and safety by combining and determining various states of a vehicle.

In accordance with an embodiment of the present invention, a method for controlling stop modes of a motor-driven power steering includes: a first step of confirming whether a vehicle speed of a vehicle is present; a second step of confirming whether an engine of the vehicle is operated; a third step of confirming whether an alternator is driven or an ignition switch is turned on or off; and a fourth step of delaying the stop of the motor-driven power steering for a predetermined different time depending on a confirmation result in the first, second, and third steps.

In the fourth step, when a combination of a first confirmation result in the first step, a second confirmation result in the second step, and a third confirmation result in the third step satisfy a pre-established condition, the motor-driven power steering may be held in an active state for a predetermined time in the condition satisfying the combination and the motor-driven power steering may stop after the time lapse.

In the fourth step, when as the first confirmation result, the vehicle speed is held at zero, as the second confirmation result, the engine is changed from an active state to an inactive state, or as the third confirmation result, the alternator is changed from a turn on state to a turn off state or the ignition switch is changed from a turn on state to a turn off state, the motor-driven power steering is determined to be in a normal stop mode and the motor-driven power steering normally may stop.

In the fourth step, when as the first confirmation result, the vehicle speed is held at zero, as the second confirmation result, the engine is changed from the active state to the inactive state, or as the third confirmation result, the alternator is held in the turn on state or the ignition switch is held in the turn on state, the motor-driven power steering is determined to be in a first abnormal stop mode, the motor-driven power steering may be held in the active state for a first time, and the motor-driven power steering may stop after the first time lapses. The first time may be 20 seconds to 40 seconds.

In the fourth step, when as the first confirmation result, the vehicle speed is held above a specific speed, as the second confirmation result, the engine is changed from the active state to the inactive state, or as the third confirmation result, the alternator is changed from the turn on state to the turn off state or the ignition switch is held from the turn on state to the turn off state, the motor-driven power steering is determined to be in a second abnormal stop mode, the motor-driven power steering may be held in the active state for a second time, and the motor-driven power steering may stop after the second time lapses. The second time may be 90 seconds to 150 seconds.

In the fourth step, when as the first confirmation result, the vehicle speed is fixed and as the second confirmation result, the engine is turned off, the motor-driven power steering may be determined to be in a third abnormal stop mode, the motor-driven power steering may be held for a predetermined time, and a warning message may be output.

The method for controlling stop modes of a motor-driven power steering may further include: at the time of performing the fourth step, a fifth step of outputting at least one warning message corresponding to the at least any one confirmation result.

### BRIEF DESCRIPTION OF THE DRAWINGS

FIG. 1 is a block diagram of a vehicle electronic control system which may adopt a method for controlling stop modes of a motor-driven power steering (MDPS) in accordance with an embodiment of the present invention.

FIG. 2 is a flow chart of a method for controlling stop modes of an MDPS in accordance with the embodiment of the present invention.

FIGS. 3 to 6 are diagrams illustrating each stop mode which is performed by the method for controlling stop modes of an MDPS of FIG. 2.

FIG. 7 is a state transition diagram in the case in which the method for controlling stop modes of an MDPS in accordance with the embodiment of the present invention is applied to specific types of vehicles.

### DESCRIPTION OF SPECIFIC EMBODIMENTS

Terms and words used in the present specification and claims are not to be construed as a general or dictionary meaning but are to be construed as meaning and concepts meeting the technical ideas of the present invention based on a principle that the inventors can appropriately define the concepts of terms in order to describe their own inventions in best mode. Therefore, configurations described in embodiments and shown in drawings of the present specification indicate only the most preferred example rather than indicating all the technical ideas of the present invention and therefore, it is to be understood that various equivalents and modifications that can replace the above configurations may be present.

Terms used in the present specification are for explaining the embodiments rather than limiting the present invention. Unless explicitly described to the contrary, a singular form includes a plural form in the present specification.

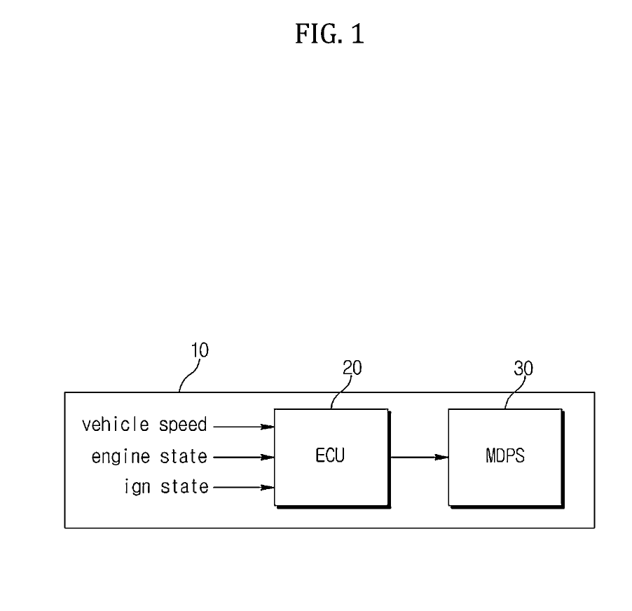

FIG. 1 is a block diagram of a vehicle electronic control system which may adopt a method for controlling stop modes of a motor-driven power steering (MDPS) in accordance with an embodiment of the present invention.

Referring to FIG. 1, a vehicle electronic control system 20 which adopts a method for controlling stop modes of an MDPS in accordance with an embodiment of the present invention confirms a vehicle speed, an engine state, an ignition switch (IGN) state, and the like, using signals from various types of sensors by being mounted in a vehicle 10 and performs a process of controlling stops node of an MDPS to be described below depending on the confirmed results.

The vehicle electronic control system 20 may include a computer-readable storage medium (not illustrated) configured to record at least a process of controlling stop modes of an MDPS and a microprocessor (not illustrated) configured to control driving modes and stop modes of the MDPS 30 mounted in the vehicle by the process for controlling stop modes of an MDPS stored in the storage medium.

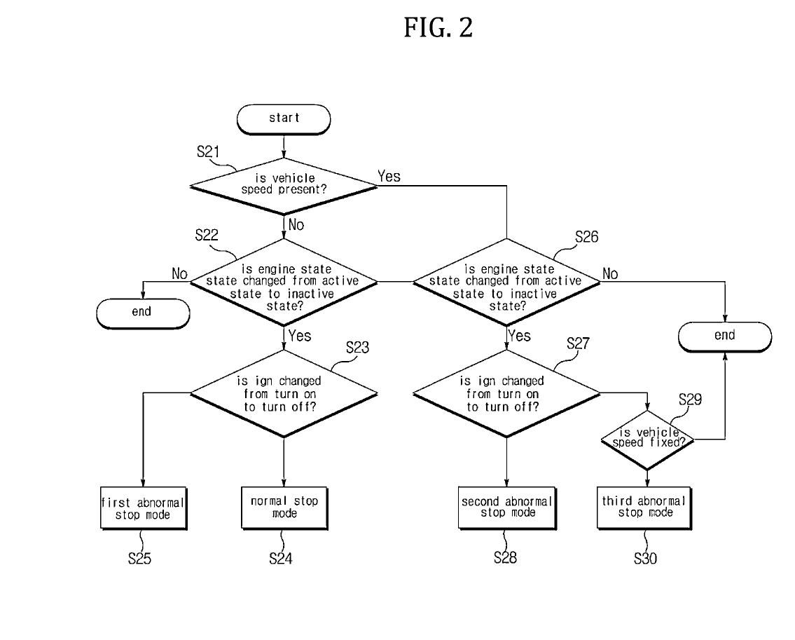

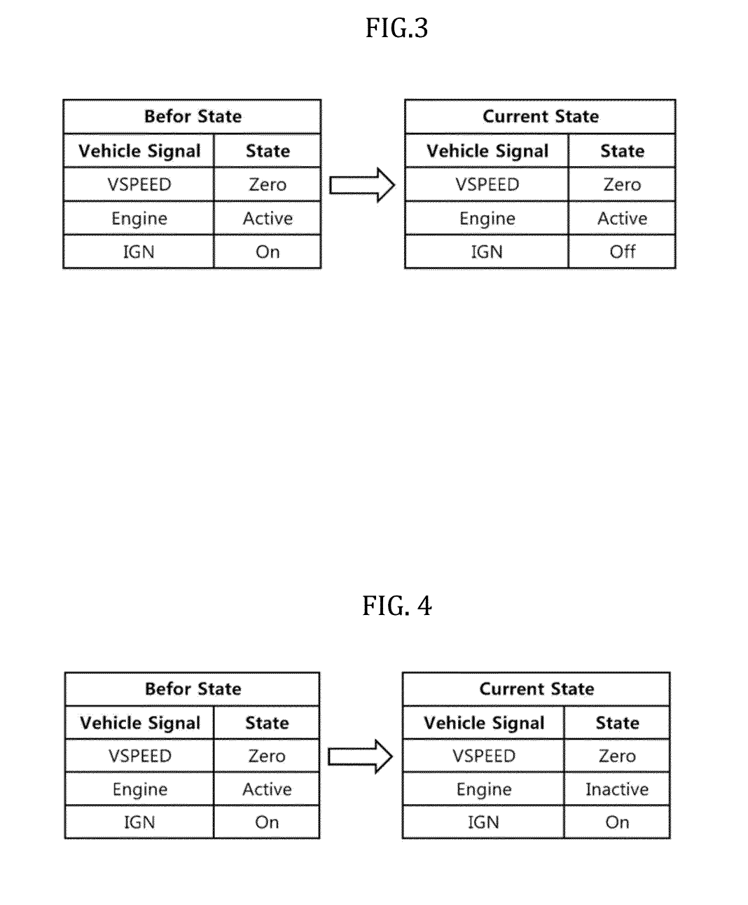

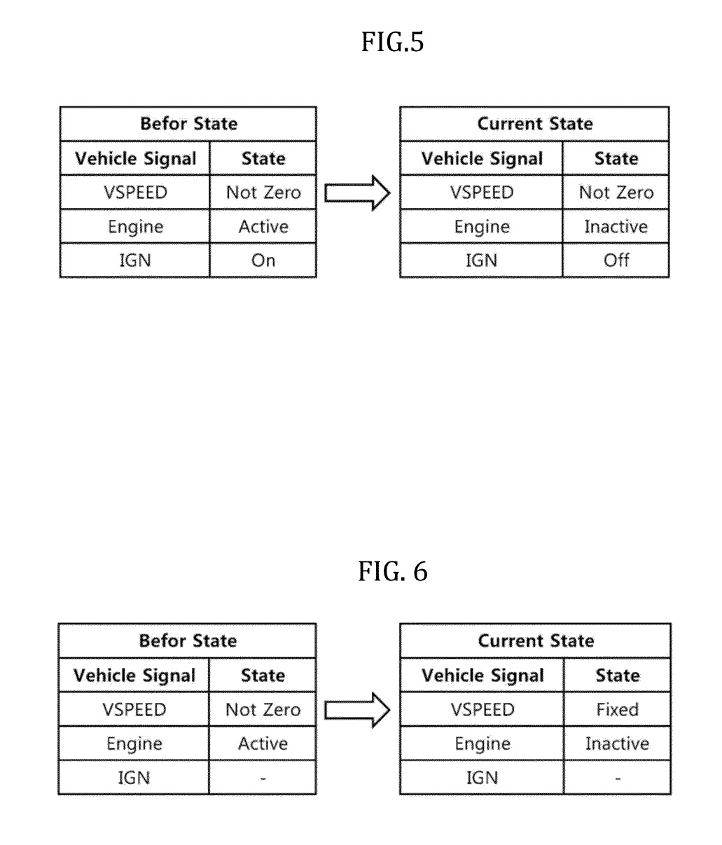

FIG. 2 is a flow chart of a method for controlling stop modes of an MDPS in accordance with the embodiment of the present invention. FIGS. 3 to 6 are diagrams illustrating each stop mode which is performed by the method for controlling stop modes of an MDPS of FIG. 2.

Referring to FIG. 2, the method for controlling stop modes of an MDPS in accordance with the embodiment of the present invention first determines whether a vehicle speed is present in the vehicle electronic control system (S21).

In step S21, it is determined whether the vehicle moves above a specific speed (measurable speed larger than zero), not, for example, zero. The vehicle speed (VSPEED) may be detected by signals input from a vehicle speed sensor mounted in the vehicle.

The vehicle electronic control system refers to one in which a means (program) for implementing the method for controlling stop modes of an MDPS in accordance with the embodiment of the present invention is mounted in a vehicle, and when an apparatus (apparatus for controlling stop modes of an MDPS) for implementing the method for controlling stop modes of an MDPS in accordance with the embodiment of the present invention is mounted separately in a vehicle, the vehicle electronic control system corresponds to the apparatus for controlling stop modes of an MDPS.

Next, as the determination result in step S21, when the vehicle speed is zero, the vehicle electronic control system determines whether an engine state of the vehicle is changed from an active state to an inactive state (S22).

In step S22, it is determined whether the vehicle is operated by an engine operation of the active state. The engine state (active/inactive) is detected by a signal received from an engine control apparatus or may be determined by signals detected by sensors used to detect the engine state, such as an engine rotation speed detection sensor, an engine ignition state monitoring sensor, and the like.

Next, as the determination result in step S22, when the engine state of the vehicle is changed to the inactive state, the vehicle electronic control system determines whether an alternator is changed from a turn on state to a turn off state or an ignition switch (IGN) is changed from a turn on state to a turn off state (S23).

In step S23, it is confirmed whether the vehicle is in the stop modes of the MDPS by a normal operation of a user (driver, and the like). The alternator is an apparatus which supplies power to various devices, such as an air conditioner, a headlight, and an audio, from initial starting of the vehicle. The alternator state may be detected by a voltage sensor or a current sensor which is connected to the alternator or a turn on or off state of a power switch (corresponding to the ignition switch) which is connected to the alternator.

Next, as the determination result in step S23, if it is determined that the alternator is changed to the turn off state or the ignition switch is changed to the turn of state, the vehicle electronic control system recognizes that the vehicle is in the normal stop modes by the user and the MDPS stops (S24).

The normal stop modes by a series of steps S21, S22, S23, and S24 as described above are shown in a table form as illustrated in FIG. 3.

Meanwhile, as the determination result in step S23, when the alternator is not changed to the turn off state but holds the turn on state or the ignition switch holds the turn on state, the vehicle electronic control system recognizes that the vehicle is in abnormal stop modes (first abnormal stop modes), not in the normal stop modes by the user and controls the MDPS so that the MDPS holds the normal operation for a predetermined first time in response to the first abnormal stop modes (S25).

The first abnormal stop mode corresponds to a mode to prevent a vehicle accident from occurring when the user re-starts the vehicle by holding a steering power for the first time under a situation in which the user does not want the MPDS stop, for example, when the user turns off the ignition of the vehicle at a sloping road by mistake. Further, the MDPS which consumes a large current is continuously operated after the ignition switch is turned off, which is a main factor of discharging a battery. In accordance with the embodiment of the present invention, the first abnormal stop mode is set to hold the steering power for the first time so as to prevent the above-mentioned MDPS from consuming a large current.

For example, the first time is about 20 seconds to about 40 seconds. The first time may be set based on time (about 20 seconds) to allow the user to re-start the vehicle several times after he/she turns off the ignition of the vehicle by mistake and time (about 40 seconds) to limit the amount of current which is consumed by the MDPS.

The first abnormal stop modes by a series of steps S21, S22, S23, and S25 as described above are shown in a table form as illustrated in FIG. 4.

On the other hand, as the determination result in step S21, when the vehicle speed holds a not zero state, the vehicle electronic control system determines whether the engine state of the vehicle is changed from the active state to the inactive state (S26).

Next, as the determination result in step S26, when the engine state of the vehicle is changed to the inactive state, the vehicle electronic control system determines whether the alternator is changed from the turn on state to the turn off state or the ignition switch (ION) is changed from the turn, on state to the turn off state (S27).

Next, as the determination result in step S27, if it is determined that the alternator is changed to the turn off state or the ignition switch is changed to the turn off state, the vehicle electronic control system recognizes that the vehicle is in abnormal stop modes (second abnormal stop modes), not in the normal stop modes by the user and controls the MDPS so that the MDPS holds the normal operation for a predetermined second time in response to the second abnormal stop modes (S28).

The second abnormal stop mode is a mode which prevents the vehicle accident from occurring and enhances the driver's safety by allowing the user to move and park the vehicle to the shoulder of a road, and the like, by holding the steering power for the second time under the situation in which the user does not want the stop of the MDPS, like the case in which the user turns off the ignition switch or the engine during the driving by mistake or at the abnormality of the vehicle.

The second time may be, for example, about 90 seconds to about 150 seconds. The second time may be set within the range of time (about 90 seconds) taken to allow the driver to easily move the vehicle to a safety zone when the ignition switch and/or the engine is turned off during the driving of the vehicle and about 90 seconds to about 150 seconds in consideration of time (about 150 seconds) to limit the amount of current which is consumed by the MDPS.

The second abnormal stop modes by a series of steps S21, S26, S27, and S28 as described above are shown in a table form as illustrated in FIG. 5.

On the other hand, as the determination result in step S27, when the alternator is not changed to the turn off state but holds the turn on state or when the ignition switch holds the turn on state, the vehicle electronic control system determines that the vehicle speed is fixed (S29).

Next, as the determination result in step S29, when the vehicle speed is fixed, the vehicle electronic control system recognizes that the vehicle is not in the normal stop modes but in the abnormal stop modes (third abnormal stop modes) by the user and holds the steering power by the MDPS or outputs a pre-established warning message for a predetermined time in response to the third abnormal stop modes (S30).

The third abnormal stop modes is to consider the driving mode or the stop mode of the MDPS when it is determined that a first condition on the state of the ignition switch, and the like during the driving of the MDPS or a second condition on the vehicle speed, and the like is in a confirmation impossible state, that is, states such as a disconnection or a short of a controller area network (CAN) line and message ability. For example, the vehicle electronic control system may hold the MDPS as the active state for a predetermined time, stop the MDPS, or output the corresponding warning message, depending on the pre-established process by coping with the abnormal stop modes (third abnormal stop modes) based on the fixing of the vehicle speed and the turn off state of the engine Which may occur at the time of the abnormality of CAN communication.

The third abnormal stop modes by a series of steps S21, S26, S27, S29, and S30 as described above are shown in a table form as illustrated in FIG. 5.

Meanwhile, an example in which the method for controlling stop modes of an MDPS in accordance with the embodiment of the present invention is applied to specific types of vehicles is shown in Table 1.

TABLE 1

| input | KEY | Engine | Speed | Mode |
|---|---|---|---|---|
| 1 | OFF | OFF | stop | stop |
| 2 | OFF | OFF | run | 120 sec mode |
| 3 | OFF | ON | stop | Full assist |
| 4 | OFF | ON | run | Full assist |
| 5 | ON | OFF | stop | 30 sec mode |
| 6 | ON | OFF | run | Full assist |
| 7 | ON | ON | stop | Full assist |
| 8 | ON | ON | run | Full assist |

As shown in Table 1, the vehicle electronic control system may control the modes of the MDPS using a stop, a stop after a 30 sec mode, a stop after a 120 sec mode, or a full assist, based on signal inputs of first to eighth steps which are acquired from the determination results depending on various states, such as an ignition key position, an engine state, a vehicle speed, and the like, of a vehicle.

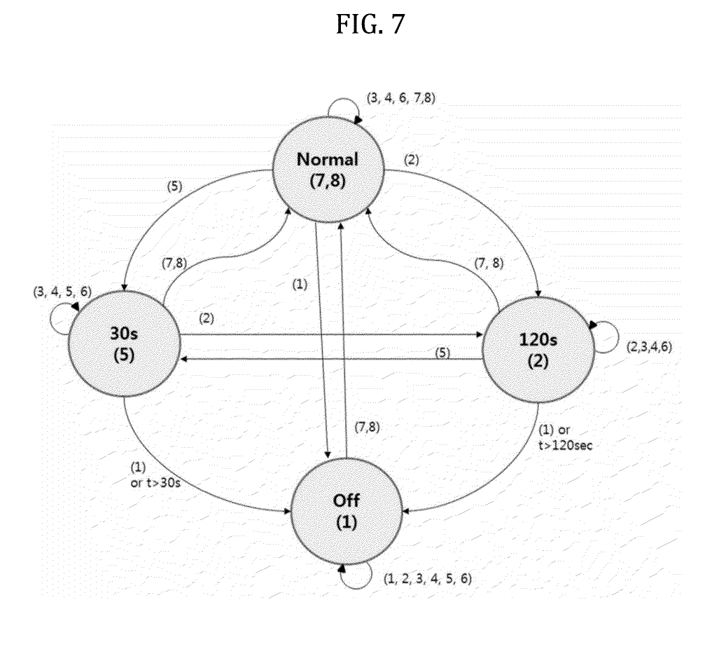

Several modes shown in Table 1 are shown by a state transition diagram illustrated in FIG. 7.

In FIG. 7, figures in brackets represent the signal inputs. Further, in the state transition of the modes of the MDPS, 30 s represents the 30 see mode, 120 s represents the 120 sec mode. Normal represents the full assist, and Off represents the stop, respectively.

In accordance with the embodiment of the present invention, the modes of the MDPS are controlled by being divided into at least pre-established eight steps, thereby effectively enhancing the driver's convenience and safety.

In the case of another implementation for the purpose of prevention of thefts, when a vehicle enters three steps (that is, when the vehicle speed is zero, the engine state is active, and the ignition key is turned off) of the above Table 1 from the stop of driving, it is determined that a vehicle theft is attempted and therefore the modes of the MDPS do not start or after the modes of the MDPS start, the modes of the MDPS may stop after a predetermined time lapses.

In accordance with the embodiments of the present invention, the stop modes of the motor-driven power steering (MDPS) may be controlled to be able to suppress the discharging of the battery while enhancing the driver's convenience and safety by combining and determining various states of a vehicle.

Although the present invention has been shown and described with the exemplary embodiment as described above, the present invention is not limited to the exemplary embodiment as described above, but may be variously changed and modified by those skilled in the art to which the present invention pertains without departing from the scope of the present invention, and the changes, substitutions, modifications, and the like are to be construed as belonging to claims of the present invention.

1. A method for controlling stop modes of a motor-driven power steering, comprising:
a first step of confirming whether a vehicle speed of a vehicle is present;
a second step of confirming whether an engine of the vehicle is operated;
a third step of confirming whether an alternator is driven or an ignition switch is turned on or off; and
a fourth step of delaying the stop of the motor-driven power steering for a predetermined different time depending on a confirmation result in the first, second, and third steps.

2. The method of claim 1, wherein in the fourth step, when a combination of a first confirmation result in the first step, a second confirmation result in the second step, and a third confirmation result in the third step satisfy a pre-established condition, the motor-driven power steering is held in an active state for a predetermined time in the condition satisfying the combination and the motor-driven power steering stops.

3. The method of claim 2, wherein in the fourth step, when as the first confirmation result, the vehicle speed is held at zero, as the second confirmation result, the engine is changed from an active state to an inactive state, or as the third confirmation result, the alternator is changed from a turn on state to a turn off state or the ignition switch is changed from a turn on state to a turn off state, the motor-driven power steering is determined to be in a normal stop mode and the motor-driven power steering normally stops.

4. The method of claim 3, wherein in the fourth step, when as the first confirmation result, the vehicle speed is held at zero, as the second confirmation result, the engine is changed from the active state to the inactive state, or as the third confirmation result, the alternator is changed from the turn on state to the turn off state or the ignition switch is held in the turn on state, the motor-driven power steering is determined to be in a first abnormal stop mode and the motor-driven power steering stops after the motor-driven power steering is held in the active state for a first time.

5. The method of claim 4, wherein the first time is 20 seconds to 40 seconds.

6. The method of claim 4, wherein in the fourth step, when as the first confirmation result, the vehicle speed is held above a specific speed, as the second confirmation result, the engine is changed from the active state to the inactive state, or as the third confirmation result, the alternator is changed from the turn on state to the turn off state or the ignition switch is held from the turn on state to the turn off state, the motor-driven power steering is determined to be in a second abnormal stop mode and the motor-driven power steering stops after the motor-driven power steering is held in the active state for a second time.

7. The method of claim 6, wherein the second time is 90 seconds to 150 seconds.

8. The method of claim 6, wherein in the fourth step, when as the first confirmation result, the vehicle speed is fixed and as the second confirmation result, the engine is turned off, the motor-driven power steering is determined to be in a third abnormal stop mode, the motor-driven power steering is held for a predetermined time, and a warning message is output.

9. The method of claim 1, further comprising:
at the time of performing the fourth step, a fifth step of outputting at least one warning message corresponding to the at least any one confirmation result.
